(19) United States
(12) Patent Application Publication
(10) Pub. No.: US 2025/0166260 A1
(43) Pub. Date: May 22, 2025

(54) METHOD AND APPARATUS FOR GENERATING EFFECT CHARACTERS, DEVICE AND STORAGE MEDIUM

(71) Applicant: Beijing Zitiao Network Technology Co., Ltd., Haidian District, Beijing (CN)

(72) Inventor: Denggao WANG, Beijing (CN)

(21) Appl. No.: 18/841,299

(22) PCT Filed: Feb. 14, 2023
(86) PCT No.: PCT/CN2023/075836

§ 371 Date: Aug. 23, 2024

(30) Foreign Application Priority Data
Feb. 25, 2022 (CN) 202210179409.9

(51) Int. Cl. G06T 11/60; G06T 3/14; G06T 3/20; G06T 3/40; G06T 5/70; G06T 11/00

(52) U.S. Cl. CPC G06T 11/60; G06T 3/14; G06T 3/20; G06T 3/40; G06T 5/70; G06T 11/001

(57) ABSTRACT

Embodiments of the disclosure disclose a method and apparatus for generating effect characters, device and storage medium. The method includes: transforming an original monochrome character image into a color character image; magnifying a set edge in the color character image in a first direction to obtain a stretch effect image; acquiring a plurality of set noise images, and disturbing pixel points in a set region of the stretch effect image in a second direction respectively according to the plurality of set noise images, to obtain a plurality of effect character images, wherein the set region includes a stretch region; and splice-coding the plurality of effect character images to obtain dynamic effect character.

The present application claims priority to Chinese Patent Application No. 202210179409.9 filed on Feb. 25, 2022 by the Chinese Patent Office, the entire contents of which are incorporated herein by reference.

### TECHNICAL FIELD

Embodiments of the present disclosure relate to the technical field of image processing, for example, to a method and apparatus for generating effect characters, device and storage medium.

### BACKGROUND

Character design, often referred to in previous user interface designs, is a font paradigm, emphasizing its shape. Character effects are rarely mentioned, but with the prevailing trend of parsimony design, even a single graphic page will immediately “live” if the character can be made to “move”, giving the user a different visual experience.

### SUMMARY

Embodiments of the present disclosure provide a method, apparatus, device and storage medium for generating effect characters.

In a first aspect, an embodiment of the present disclosure provides a method for generating effect character, including:
transforming an original monochrome character image into a color character image;
magnifying a set edge in the color character image in a first direction to obtain a stretch effect image;
acquiring a plurality of set noise images, and disturbing pixel points in a set region of the stretch effect image in a second direction respectively according to the plurality of set noise images, to obtain a plurality of effect character images, wherein the set region includes a stretch region; and
splice-coding the plurality of effect character images to obtain dynamic effect character.

In a second aspect, an embodiment of the present disclosure further provides an apparatus for generating effect character, the apparatus includes a color character image acquiring module, a stretch effect image acquiring module, an effect character image acquiring module,
the color character image acquiring module is configured to transform an original monochromatic character image into a color character image and a dynamic effect character acquiring module,
the stretch effect image acquiring module is configured to magnify a set edge in the color character image in a first direction to obtain a stretch effect image;
the effect character image acquiring module is configured to acquire a plurality of set noise images and disturb pixel points in a set region of the stretch effect image in a second direction respectively according to the plurality of set noise images to obtain a plurality of effect character images, wherein the set region includes a stretch region; and
the dynamic effect character acquiring module is configured to splice-code the plurality of effect character images to obtain dynamic effect character.

In a third aspect, an embodiment of the present disclosure further provides an electronic device including one or more processing devices and a storage device, the storage device is configured to store one or more programs;
the one or more programs, when executed by the one or more processing devices, cause the one or more processing devices to implement the method for generating effect character according to embodiments of the present disclosure.

In a fourth aspect, an embodiment of the present disclosure further provides a computer readable medium having stored thereon a computer program which, when executed by a processing device, implements the method of generating effect character according to embodiments of the present disclosure.

### BRIEF DESCRIPTION OF DRAWINGS

FIG. 1 is a flowchart of a method of generating effect characters in an embodiment of the present disclosure;

FIG. 2 is a schematic diagram of transforming from an original monochrome image to a color character image in an embodiment of the present disclosure;

FIG. 3 is an example diagram of edge distorting a color character in an embodiment of the present disclosure;

FIG. 4 is an example diagram of acquiring a stretch effect image in an embodiment of the present disclosure;

FIG. 5 is an example diagram of hybrid overlaying an original monochrome character image and a stretch effect image in an embodiment of the present disclosure;

FIG. 6 is an example diagram of disturbing a set region in a second direction in an embodiment of the present disclosure;

FIG. 7 is a structural schematic diagram of an apparatus for generating effect characters according to an embodiment of the present disclosure;

FIG. 8 is a structural schematic diagram of an electronic device in an embodiment of the present disclosure.

### DETAILED DESCRIPTION

It should be understood that the various steps recited in the method implementation of the present disclosure may be executed in a different order, and/or in parallel. Further, the method implementation may include additional steps and/or omit performing illustrated steps. The scope of the present disclosure is not limited in this regard.

As used herein, the term “include” and variations thereof are open inclusion, that is, “including, but not limited to”. The term “based on” is “based at least in part on.” The term “one embodiment” means “at least one embodiment”. The term “another embodiment” means “at least one additional embodiment”. The term “some embodiments” means “at least some embodiments”. Relevant definitions for other terms will be given in the description below.

Note that the concepts of “first”, “second”, and the like mentioned in the present disclosure are used only to distinguish different devices, modules, or units, and are not used to limit the order or interdependence of functions performed by these devices, modules, or units.

It is noted that the modifications referred to in the present disclosure as “a”, “a plurality” are illustrative rather than limiting, and those skilled in the art should understand that it should be understood as “one or more” unless the context clearly dictates otherwise.

The names of messages or information interacted between devices in an implementation of the present disclosure are for illustrative purposes only and are not intended to limit the scope of such messages or information.

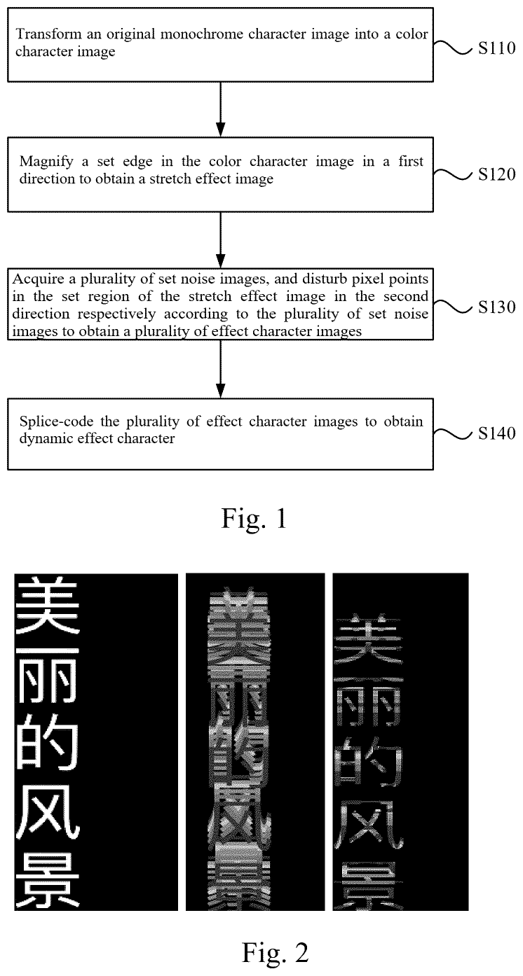

FIG. 1 is a flowchart illustrating a method for generating effect character according to an embodiment of the present disclosure, which may generate effect characters, the method may be performed by an effect character generating apparatus, which may be composed of hardware and/or software, and may be generally integrated in a device having an effect character generating function, the device may be an electronic device such as a server, a mobile terminal, or a server cluster. As shown in FIG. 1, the method includes the steps of:

S110, transforming an original monochrome character image into a color character image.

Therein, the original monochromatic character image may be a static image filled with a single color in characters, for example: white. A color character image can be understood as a static image in which the characters are filled with color.

In this embodiment, the original monochrome character image may be transformed into a color character image by obtaining position information of each pixel point constituting the character, obtaining color information from a set color bar based on the position information, and using the color information as a final color of the pixel point. In which, the manner of acquiring the color information from the set color bar according to the position information may be to: take the abscissa value or the ordinate value of the pixel point as index information, and acquire the color information from the set color bar according to the index information.

In an example, the original monochrome character image may be transformed into a color character image by: copying the original monochrome character image in multiple copies to obtain a plurality of copied monochrome character images; mapping the characters in the plurality of copied monochromatic character images to different colors, respectively, to obtain a plurality of color images; moving the plurality of color images by at least partially different offsets in the second direction, respectively; color filter overlaying the plurality of shifted color images and the original monochromatic character image to obtain an overlaid image; masking the overlaid image by using the original monochrome character image to obtain a color character image.

For example, the different colors may be colors in red, orange, yellow, green, cyan, blue and purple. The second direction is associated with the ordering direction of the characters in the image, the second direction is longitudinal direction if the ordering direction of the characters is longitudinal direction, and the second direction is transverse direction if the ordering direction of the characters is transverse direction. The offsets of the plurality of color images may be partially different or all different, for example, may gradually increase. Exemplarily, assuming that three monochromatic character images are copied and the mapped colors are red, green, and yellow, respectively, the red character image is shifted by d in the second direction, the green character image is shifted by 2d in the second direction, and the yellow character image is shifted by 3d in the second direction.

The process of masking the overlaid image by using the original monochrome character image may be performed by: aligning the original monochrome character image with the overlaid image, and for each pixel point constituting the character in the original monochrome character image, taking the color of the corresponding pixel in the overlaid image as the color of the pixel point to obtain a color character image. Illustratively, FIG. 2 is a diagram illustrating the conversion of an original monochromatic image to a color character image in the present embodiment. As shown in FIG. 2, the left image is an original monochromatic image, the middle image is an overlaid image, and the right image is a color character image obtained after masking. In this embodiment, the color character is obtained by masking the overlaid image through the original monochrome character, and the smoothness of the generated color character can be guaranteed.

In an example, after transforming the original monochrome character image into the color character image, the step of edge distorting the color character in the color character image to obtain an edge distorted color image is further included.

For example, the edge may be an edge portion that accounts for a certain proportion of the size of the character, which may be 20%-30%, and may be a left side edge, a right side edge, an upper side edge, or a lower side edge. The position of the edge is related to the ordering direction of the characters, and if the ordering direction is longitudinal, the left edge or the right edge is selected, and if the ordering direction is transverse, the upper edge or the lower edge is selected.

In this embodiment, edge distorting the color characters in the color character image may be performed using a custom water moire function, noise interference, or stripe noise image.

In an example, the color characters in the color character image are edge distorted, and the edge distorted color image may be obtained by: obtaining a stripe noise image; disturbing the edges of the color characters in the color character image in a first direction according to the grayscale information of the stripe noise to obtain the edge distorted color image.

For example, the stripe noise image may be an image including a plurality of brightness gradient stripes, the stripes having a certain width and a certain spacing between adjacent stripes. In this embodiment, the stripe noise image can be custom drawn by a technician. The width of the stripes can control the wave width and crest spacing of the distortion, and the grayscale information can control the crest height of the distortion.

For example, the first direction is associated with the ordering direction of the characters, the first direction is the transverse direction if the ordering direction is the longitudinal direction, and the first direction being the longitudinal direction if the ordering direction is the transverse direction. The disturbing the edges of the color characters in the color character image in the first direction according to the grayscale information of the stripe noise image may be understood as: changing the first direction coordinate values of the color characters edge pixel points according to the grayscale information of the stripe noise image, thereby achieving distorting of the character edges. In this embodiment, the color character is edge distorted by the stripe noise image, and the adaptation of the distorting can be improved.

In an example, disturbing the edges of the color characters in the color character image in the first direction according to the grayscale information of the stripe noise image, to obtain the edge distorted color image may include: aligning the stripe noise image with the color character image; acquiring, for each pixel point of the edge portion of the color character, grayscale information of the pixel point aligned with the pixel point in the stripe noise image; accumulating the grayscale information with the coordinate value of the pixel point in the first direction to obtain coordinate value of the disturbed pixel point in the first direction, to obtain the edge distorted color image.

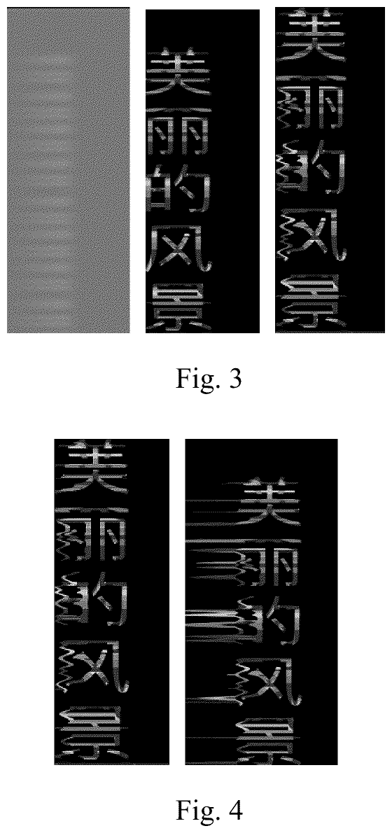

For example, the grayscale information may be characterized by a value of any one of RGB channels, or by an average value of three channels of RGB. For example, for each pixel point of the edge portion of the color character, the first direction coordinate value of the pixel point is accumulated with the grayscale value of corresponding pixel point of the pixel point in the stripe noise image to obtain the disturbed first direction coordinate value, the second direction coordinate value is kept unchanged, and finally the pixel point is moved to a position corresponding to the disturbed first direction coordinate value and the second direction coordinate value, thereby obtaining the edge distorting image. Illustratively, FIG. 3 is a diagram illustrating edge distorting of color character in this embodiment. As shown in FIG. 3, the left image is a stripe noise image, the middle image is a color character image, and the right image is an edge distorted color image obtained by disturbing the left edges of the characters in the color character image by the stripe noise image. In this embodiment, the edges of the color characters are disturbed in the first direction based on the grayscale information of the noise interference image, which can improve the efficiency of generating the edge distorted color image.

S120, magnifying a set edge in the color character image in a first direction to obtain a stretch effect image.

For example, the set edge may be an edge portion that accounts for a certain proportion (may be 20%-30%) of the size of the characters, and may be a left side edge, a right side edge, an upper side edge, or a lower side edge. The position of the edge is related to the ordering direction of the characters, the left edge or the right edge is selected if the ordering direction is longitudinal, and the upper edge or the lower edge is selected if the ordering direction is transverse. Magnifying the set edge in the color character image in the first direction can be understood as: magnifying the set edge in the first direction by a set factor, keeping the second direction unchanged to obtain a stretch effect image. The principle of image magnification may be implemented in any manner known in the art and is not intended to be limiting herein. In this embodiment, the stretch effect image exhibits a “ribbon” effect.

In one example, magnifying a set edge of the color character image in the first direction to obtain the stretch effect image may be by magnifying a twisted edge of the edge twisted color image in the first direction to obtain the stretch effect image.

For example, the entire region or part of the region of the twisted edge is magnified by a set factor in the first direction while the second direction is kept unchanged to obtain a stretch effect image. Illustratively, FIG. 4 is an example of obtaining a stretch effect image in this embodiment. As shown in FIG. 4, the left image is an edge distortion color image and the right image is a stretch effect image.

In an example, after obtaining the stretch effect image, further including: hybrid overlaying the original monochromatic character image with the stretch effect image, to obtain an overlaid stretch effect image.

For example, hybrid overlaying the original monochromatic character image with the stretch effect image may be understood as overlaying monochromatic characters in the original monochromatic character image over color characters in the stretch effect image such that the overlaid stretch effect image exhibits the effect of “monochromatic characters drifting out of a color band”.

For example, the process of hybrid overlaying the original monochromatic character image with the stretch effect image to obtain the stretch effect image may include: blurring the stretch effect image with a first blur degree to obtain a first blurred stretch image; hybridizing the first blur stretch image and the stretch effect image according to a set hybrid rule to obtain a first hybrid image; aligning the characters in the original monochromatic character image with the characters in the first hybrid image, and shifting the characters in the aligned original monochromatic character image by a set offset in the second direction to obtain an overlaid stretch effect image.

For example, the characters of the original monochromatic character image of the overlaid stretch effect image are positioned above the characters of the first hybrid image. The blurring process may be performed by performing a double-layer Gaussian blurring process and a downsampling process on the stretch effect image, thereby obtaining a first blurred stretch image. The hybrid rule may be a hybrid ratio of pixel values or color values of the first blurred stretch image and the stretch effect image, the hybrid ratio may be unchanged or changed according to a certain rule. For example, when the two images are hybridized, the pixels from one edge to the other edge are hybridized at the same hybrid ratio, or the hybrid ratio is gradually changed from a first setting value (e.g., 1) to a second setting value (e.g., 0) from one edge to the other edge, and then gradually changed from the second setting value to the first setting value.

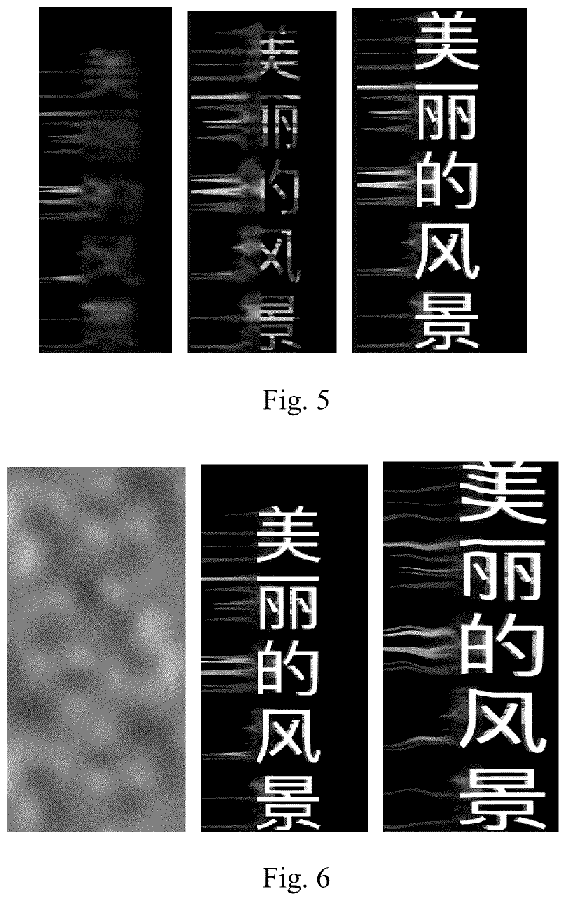

In this embodiment, by shifting the characters in the original monochromatic charactering image after alignment by the set offset in the second direction, a portion of the color characters below can be exposed and the display effect can be improved. Illustratively, FIG. 5 is an illustration of an example in which an original monochromatic character image is hybridized with a stretch effect image. In this example, the stretch effect image is blurred and then hybridized with the original monochromatic character image to soften the edges of the color band.

In an example, hybridizing the first blurred stretch image and the stretch effect image according to a set hybrid rule to obtain the first hybrid image may include: aligning the first blurred stretch image and the stretch effect image, obtaining first direction coordinate values of aligned pixel points; determining a hybrid ratio according to the first direction coordinate value; hybridizing the aligned pixel points according to the hybrid ratio to obtain a first hybrid image.

For example, the hybrid ratio is the ratio of the stretching effect image to the first blur stretching image, the hybrid ratio may be a value between 0-1. In this embodiment, the correspondence between the first direction coordinate value and the hybrid ratio may be established in advance. Exemplarily, taking the stretching effect image obtained in FIG. 4 as an example, the correspondence can be established by dividing the image into three sub-regions in the left-to-right direction, the three sub-regions being at a ratio of 20%, 10% and 70%, respectively, wherein the hybrid intensity is gradually changed from 1 to 0 from left to right in the first sub-region, the hybrid intensity is gradually changed from 1 to 1 from left to right in the second sub-region, and the hybrid intensity is kept unchanged at 1 in the third sub-region. For example, the manner of hybridizing the aligned pixel points according to the hybrid ratio may be to hybrid color values (RGB) of the pixel points according to the hybrid ratio. Exemplarily, as shown in FIG. 5, the left image is the first blurred stretch image after blurring, the middle image is the first hybrid image after hybridizing the first blurred stretch image and the stretch effect image, and the right image is the stretch effect image after hybrid overlaying the characters in the original monochromatic character image with the first hybrid image. In this embodiment, the hybrid ratio is determined according to the first direction coordinate value, and the smoothness of the first hybrid image can be improved.

In an example, hybrid overlying the original monochromatic character image and the stretch effect image to obtain the stretch effect image may include: blurring the stretch effect image with a second blur degree to obtain a second blurred stretch image; hybridizing the first blur stretch image and the second blur stretch image according to a set hybrid rule to obtain a second hybrid image; aligning the characters in the original monochromatic character image with the characters in the second hybrid image, and shifting the characters in the aligned original monochromatic character image by a set offset in a second direction to obtain an overlaid stretch effect image.

For example, the second blur degree is less than the first blur degree. The characters of the original monochromatic character image in the overlaid stretch effect image is positioned above the characters of the second hybrid image. Hybridizing the first blurred stretch image and the second blurred stretch image according to the set hybrid rule to obtain the second hybrid image may include: aligning the first blurred stretch image and the second blurred stretch image, obtaining first direction coordinate values of aligned pixel points; determining a hybrid ratio according to the first direction coordinate value; hybridizing the aligned pixel points according to the hybrid ratio to obtain a second hybrid image. In this embodiment, the smoothness of the second hybrid image can be improved by hybridizing the two blurred images according to a set hybrid rule.

S130, acquiring a plurality of set noise images, and disturbing pixel points in the set region of the stretch effect image in the second direction respectively according to the plurality of set noise images to obtain a plurality of effect character images.

For example, the set region includes a stretch region, that is, the set region includes a stretch region and a portion of a character region. The set noise image may be a Tyson polygon noise or a Voronoi Noise. The second direction may be a direction perpendicular to the first direction. Disturbing the pixel points in the set regions of the stretch effect image in the second direction respectively according to the plurality of set noise images may be understood as: changing the second direction coordinate values of the pixel points in the set regions according to the grayscale information of the set noise images, so that the set regions are distorted in the second direction.

It will be appreciated that the stretching region may be the operating region corresponding to the magnifying operation of the set edge.

For example, acquiring a plurality of set noise images, and respectively disturbing the pixel points in the set region of the stretch effect image in the second direction according to the plurality of set noise images to obtain the plurality of effect character images may include: aligning the set noise image with the stretch effect image, acquiring, for each pixel point of the set region, grayscale information of the pixel point aligned with the pixel point in the set noise image; and accumulating the grayscale information and the coordinate value of the pixel point in the second direction to obtain the coordinate value of the disturbed pixel point in the second direction to obtain the effect character image.

For example, the grayscale information may be characterized by a value of any one of RGB channels, or by an average value of three channels of RGB. For example, for each pixel point of the set region, the second direction coordinate value of the pixel point is accumulated with the grayscale value of corresponding pixel point of the pixel point in the set noise image to obtain the second direction coordinate value after disturbing, the first direction coordinate value remains unchanged, and finally the pixel point is moved to a position corresponding to the second direction coordinate value after disturbing and the first direction coordinate value, thereby obtaining the effect character image. Illustratively, FIG. 6 is an example of disturbing the set region in the second direction in the present embodiment. As shown in FIG. 6, the left image is a set noise image, the middle image is a stretching effect image, and the right image is an effect image after disturbing. As shown in FIG. 6, in the effect characters, the set region containing the stretch region is twisted in the second direction. In this embodiment, the “ribbon wiggle” effect can be achieved by using the set noise image to disturb the stretch effect image in the second direction.

In an example, the process of accumulating the grayscale information with the coordinate value of the pixel point in the second direction to obtain the coordinate value of the disturbed pixel point in the second direction may include: determining an accumulated weight according to the distance of the pixel point from the character in the first direction; and accumulating a result obtained by multiplying the grayscale information with the accumulated weight with the coordinate value of the pixel point in the second direction to obtain the second direction coordinate value of the disturbed pixel point.

For example, the accumulated weight is inversely proportional to the distance, i.e., the further the pixel point is from the character in the first direction, the greater the accumulated weight. The accumulated weight may be a value between 0-1. The distance of the pixel point from the character in the first direction may be understood as the distance of the pixel point from the centre line of the character in the second direction. For example, after obtaining the accumulated weight, the accumulated weight is multiplied by the grayscale information, and then the multiplied grayscale information is added to the coordinate value of the pixel point in the second direction, thereby obtaining the coordinate value of the disturbed pixel point in the second direction. In this embodiment, the grayscale information multiplied by the accumulated weight is accumulated with the coordinate value of the pixel point in the second direction to obtain the second direction coordinate value of the disturbed pixel point, and the smoothness of the wiggle can be improved and the sense of frustration at the critical point can be reduced.

S140, splice-coding the plurality of effect character images to obtain dynamic effect character.

For example, the effect character image may be an image in which the set region in the stretch effect image is twisted in the second direction. For example, after obtaining a plurality of effect character images, the plurality of effect character images are splice-coded to obtain a dynamic effect character.

In one example, multiple effect character images may be spliced to obtain a multi-frame image, which is then coded into a moving image, i.e., to obtain dynamic effect character.

In one example, after obtaining the plurality of effect character images, the step of periodically adjusting intensity coefficients of saturation levels of the plurality of effect character images is further included.

For example, each of the effect character images corresponds to time stamp information, and the intensity coefficients of the saturation levels of the plurality of effect character images are periodically adjusted according to time. In this embodiment, periodic adjustment of the intensity coefficients of the saturation of the plurality of effect character images may cause the generated dynamic effect character to exhibit the effect of periodic variations in intensity.

In an example, after obtaining the plurality of effect character images, further including: for each pixel point in the set region, determining index information according to grayscale information of the pixel point and time stamp information of a current effect character image; obtaining the target color from the set color bar according to the index information; replacing the color of the pixel point with the target color.

In this embodiment, the grayscale value may be accumulated with the time stamp information to obtain the index information. That is, the index information may be represented as Uv=(grayscale value+time stamp, 0.5). Where Uv may represent coordinate information on a set color bar. For example, after the index information of the pixel point is obtained, the color corresponding to the index information is obtained from the set color bar, and the color is determined as the target color, and finally the color of the pixel point is replaced with the target color. In this embodiment, the color system of the ribbon can be changed by replacing the color of the pixel point with the target color on the set color bar, thereby improving the “ribbon” display effect.

Embodiments of the present disclosure transform an original monochrome character image into a color character image; magnifying a set edge in the color character image in a first direction to obtain a stretch effect image; acquiring a plurality of set noise images, and respectively disturbing pixel points in the set region of the stretch effect image according to the plurality of set noise images in the second direction to obtain a plurality of effect character images, wherein the set region includes a stretch region; and splice-coding the plurality of effect character images to obtain dynamic effect character. The method for generating effect characters according to the embodiments of the present disclosure can generate characters of stretch and fly effects, and can improve the smoothness and display effect of the effect characters.

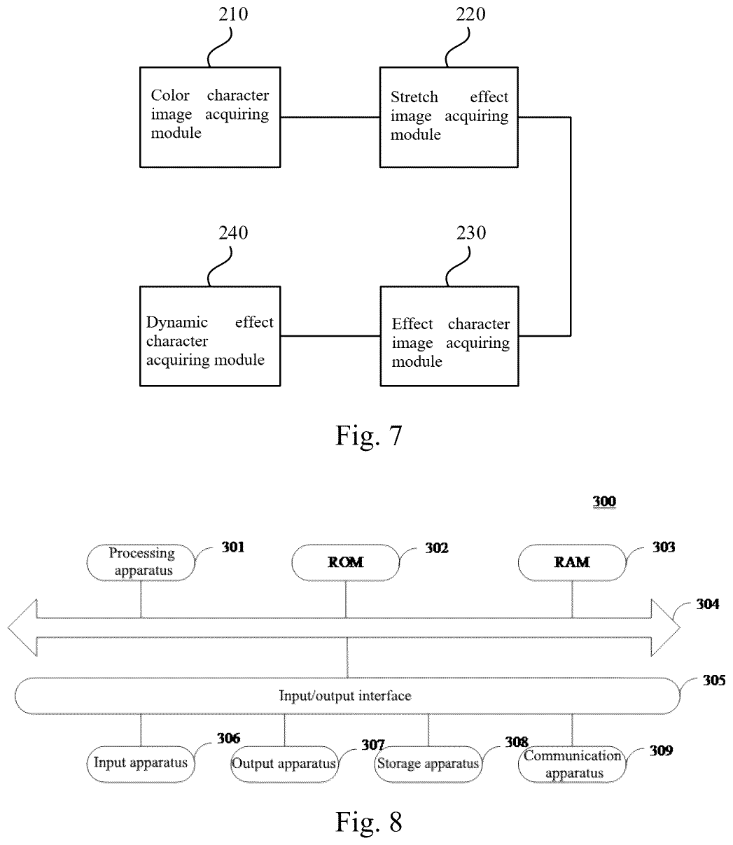

FIG. 7 is a structural schematic diagram of an apparatus for generating effect character according to an embodiment of the present disclosure, and as shown in FIG. 7, the apparatus includes a color character image acquiring module 210, a stretch effect image acquiring module 220, an effect character image acquiring module 230 and a dynamic effect character acquiring module 240,
the color character image acquiring module 210 is configured to transform the original monochromatic character image into a color character image;
the stretch effect image acquiring module 220 is configured to magnify a set edge in the color character image in a first direction to obtain a stretch effect image;
the effect character image acquiring module 230 is configured to obtain a plurality of set noise images and disturb pixel points in the set region of the stretch effect image in a second direction respectively according to the plurality of set noise images to obtain a plurality of effect character images; Wherein the set region includes a stretch region;
the dynamic effect character acquiring module is configured to splice-encode the plurality of effect character images to obtain dynamic effect character.

In an embodiment, the color character image acquiring module 210 is further configured to:
copy the original monochromatic character image in multiple copies to obtain a plurality of copied monochromatic character images;
map characters in the plurality of copied monochrome character images to different colors, respectively, to obtain a plurality of color images;
move the plurality of color images by at least partially different offsets in the second direction, respectively;
color-filter overlay a plurality of shifted color images and the original monochromatic character image to obtain an overlaid image; and
mask the overlaid image by using the original monochrome character image to obtain a color character image.

In an embodiment, the apparatus further includes an edge distorting module, which is configured to: edge distort color characters in the color character image to obtain an edge distorted color image;

In an embodiment, the stretch effect image acquiring module 220 is further configured to:
magnify a distorted edge of the edge distorted color image in the first direction to obtain a stretch effect image.

In an embodiment, the edge distorting module is further configured to:
acquire a stripe noise image; and
disturb edges of the color characters in the color character image in the first direction according to grayscale information of the stripe noise image to obtain the edge distorted color image.

In an embodiment, the edge distorting module is further configured to:
align the stripe noise image with the color character image;
acquire, for each pixel point of edge portions of the color characters, grayscale information of a pixel point aligned with the each pixel point in a stripe noise image;
accumulate the grayscale information with a coordinate value of the each pixel point in the first direction to obtain a first direction coordinate value of disturbed pixel point, to obtain the edge distorted color image.

In an embodiment, the apparatus further includes an overlaying module, which is configured to: hybrid overlay the original monochromatic character image with the stretch effect image to obtain an overlaid stretch effect image.

In an embodiment, the overlaying module is further configured to:
blur the stretch effect image with a first blur degree to obtain a first blurred stretch image;
hybrid the first blurred stretch image and the stretch effect image according to a set hybrid rule to obtain a first hybrid image; and
align characters in the original monochromatic character image with characters in the first hybrid image and shift aligned characters in the original monochromatic character image by a set offset in the second direction to obtain the overlaid stretch effect image, wherein the characters of the original monochromatic character image in the overlaid stretch effect image is positioned above the characters of the first hybrid image.

In an embodiment, the overlaying module is further configured to:
align the first blurred stretch image and the stretch effect image, and acquire first direction coordinate values of aligned pixel points;
determine a hybrid ratio according to the first direction coordinate values; and
hybrid the aligned pixel points according to the hybrid ratio to obtain the first hybrid image, wherein the hybrid ratio is a ratio of the stretch effect image to the first blurred stretch image.

In an embodiment, the overlaying module is further configured to:
blur the stretch effect image with a second blur degree to obtain a second blurred stretch image, wherein the second blur degree is less than the first blur degree;
hybrid the first blur stretch image and the second blur stretch image according to a set hybrid rule to obtain a second hybrid image; and
align the characters in the original monochromatic character image with characters in the second hybrid image, and shift aligned characters in the original monochromatic character image by a set offset in the second direction to obtain the overlaid stretch effect image, wherein the characters of the original monochromatic character image in the overlaid stretch effect image is positioned above the characters of the second hybrid image.

In an embodiment, the effect character image acquiring module 230 is further configured to:
align the set noise image with the stretch effect image,
acquire, for each pixel point of the set region, grayscale information of a pixel point aligned with the each pixel point in a set noise image; and
accumulate the grayscale information and coordinate value of the each pixel point in the second direction to obtain a second direction coordinate value of a disturbed pixel point, to obtain the effect character image.

In an embodiment, the effect character image acquiring module 230 is further configured to:
determine an accumulated weight based on a distance of the each pixel point from characters in the first direction, wherein the accumulated weight is inversely proportional to the distance; and
accumulate a result obtained by multiplying the grayscale information with the accumulated weight with the coordinate value of the each pixel point in the second direction to obtain the second direction coordinate value of the disturbed pixel point.

In an embodiment, the apparatus further includes an intensity adjusting module, which is configured to:
periodically adjust intensity coefficients of saturation levels of the plurality of effect character images.

In an embodiment, the apparatus further includes a color replacement module, which is configured to:
determine, for each pixel point in the set region, index information according to grayscale information of the each pixel point and time stamp information of a current effect character image;
obtain a target color from a set color bar according to the index information; and
replace a color of the each pixel point with the target color.

The apparatus described above may perform the methods provided by all the embodiments described above in the present disclosure, with corresponding functional modules and effects to perform the methods described above. The technical details, which are not elaborately described in the present embodiment, can be referred to the methods provided by all embodiments of the present disclosure.

Reference is now made to FIG. 8, which illustrates a schematic structural diagram of an electronic device 300 suitable for use in implementing embodiments of the present disclosure. The electronic device in the embodiment of the present disclosure may include, but is not limited to, a mobile terminal such as a mobile phone, a notebook computer, a digital broadcast receiver, a Personal Digital Assistant (PDA), a tablet computer (PAD), a Portable Media Player (PMP), a vehicle-mounted terminal (e.g., a vehicle-mounted navigation terminal), or the like, and a fixed terminal such as a digital Television (TV), a desktop computer, or the like, or various forms of servers such as a stand-alone server or a server cluster. The electronic device illustrated in FIG. 8 is merely one example and should not bring any limitation to the scope of functionality and use of embodiments of the present disclosure.

As shown in FIG. 8, the electronic device 300 may include a processing means (e.g., a central processor, a graphics processor, etc.) 301 that may execute various appropriate actions and processes according to a program stored in a Read-Only Memory (ROM) 302 or a program loaded from a storage 308 into a Random Access Memory (RAM) 303. In the RAM 303, various programs and data required for the operation of the electronic device 300 are also stored. The processing device 301, the ROM 302 and the RAM 303 are connected to each other by a bus 304. An Input/Output (I/O) interface 305 is also connected to the bus 304.

In general, the following devices may be connected to the I/O interface 305: input devices 306 including, for example, touchscreens, touchpads, keyboards, mice, cameras, microphones, accelerometers, gyroscopes, etc.; an output device 307 including, for example, a Liquid Crystal Display (LCD), a speaker, a vibrator, or the like; storage 308 including, for example, magnetic tape, hard disk, etc.; and a communication device 309. The communication means 309 may allow the electronic device 300 to engage in wireless or wired communication with other devices to exchange data. While FIG. 8 illustrates electronic device 300 with various means, it should be understood that it is not required that all of the illustrated means be implemented or provided. More or fewer devices may optionally be implemented or provided.

In particular, according to an embodiment of the present disclosure, the processes described above with reference to the flow charts may be implemented as a computer software program. For example, embodiments of the present disclosure include a computer program product including a computer program carried on a computer readable medium, the computer program containing program code for performing the method for recommending words. In such an embodiment, the computer program may be downloaded and installed from the network via the communication device 309, or installed from the storage device 308, or installed from the ROM 302. When this computer program is executed by the processing device 301, the above-described functions defined in the methods of the embodiments of the present disclosure are performed.

It should be noted that the above-described computer-readable medium of the present disclosure may be a computer-readable signal medium or a computer-readable storage medium or any combination of both. A computer readable storage medium may be, for example, but not limited to, an electronic, magnetic, optical, electromagnetic, infrared, or semiconductor system, apparatus, or device, or any combination of the foregoing. Examples of a computer readable storage medium may include, but are not limited to, an electrical connection having one or more wires, a portable computer diskette, a hard disk, a random access memory (RAM), a read-only memory (ROM), an Erasable Programmable Read-Only Memory (EPROM or Flash memory), an optical fiber, a portable Compact Disc Read-Only Memory (CD-ROM), an optical storage device, a magnetic storage device, or any suitable combination of the foregoing. In the present disclosure, a computer readable storage medium may be any tangible medium that contains, or stores a program for use by or in connection with an instruction execution system, apparatus, or device. While in the present disclosure, a computer readable signal medium may include a propagated data signal with computer readable program code embodied therein, either in baseband or as part of a carrier wave. Such a propagated data signal may take many forms, including, but not limited to, an electromagnetic signal, an optical signal, or any suitable combination of the foregoing. A computer readable signal medium may also be any computer readable medium that is not a computer readable storage medium that can communicate, propagate, or transport a program for use by or in connection with an instruction execution system, apparatus, or device. Program code embodied on a computer readable medium may be transmitted using any appropriate medium, including but not limited to wireline, fiber optic cable, Radio Frequency (RF), etc., or any suitable combination of the foregoing.

In some implementation, the clients, servers may communicate using any currently known or future developed network protocol, such as HTTP, and may be interconnected with any form or medium of digital data communication (e.g., a communication network). Examples of communication networks include a Local Area Network (LAN), a Wide Area Network (WAN), an Internet (e.g., the Internet), and a peer-to-peer network (e.g., an ad hoc peer-to-peer network), as well as any currently known or future developed network.

The above-mentioned computer-readable medium may be included in the above-mentioned electronic device; It may also be present separately and not incorporated into the electronic device.

The computer-readable medium carries one or more programs that, when executed by the electronic device, cause the electronic device to: transform an original monochrome character picture into a color character picture; magnifying a set edge in the color character image in a first direction to obtain a stretch effect image; acquiring a plurality of set noise images, and disturbing pixel points in the set region of the stretch effect image in a second direction respectively according to the plurality of set noise images, to obtain a plurality of effect character images, wherein the set region includes a stretch region; and splice-encoding the plurality of effect character images to obtain dynamic effect character.

The storage medium may be a non-transitory storage medium.

Computer program code for carrying out operations of the present disclosure may be written in one or more programming languages or combinations thereof, including without limitation an object oriented programming language such as Java, Smalltalk, C++ and conventional procedural programming languages, such as the “C” programming language or similar programming languages. The program code may execute entirely on the user's computer, partly on the user's computer, as a stand-alone software package, partly on the user's computer and partly on a remote computer or entirely on the remote computer or server. In the scenario involving a remote computer, the remote computer may be connected to the user's computer through any type of network, including a local area network (LAN) or a wide area network (WAN), or the connection may be made to an external computer (for example, through the Internet using an Internet Service Provider).

The flowchart and block diagrams in the figures illustrate the architecture, functionality, and operation of possible implementations of systems, methods, and computer program products according to various embodiments of the present disclosure. In this regard, each block in the flowchart or block diagrams may represent a module, segment, or portion of code, which includes one or more executable instructions for implementing the specified logical function(s). It should also be noted that, in some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or operations or combinations of special purpose hardware and computer instructions.

The units described in the embodiments of the present disclosure may be implemented by means of software or by means of hardware. Therein, the name of a unit does not in any case constitute a limitation of the unit per se.

The functionality described above herein can be performed, at least in part, by one or more hardware logic components. For example, and without limitation, illustrative types of hardware logic components that can be used include Field-programmable Gate Arrays (FPGAs), Application Specific Integrated Circuits (ASICs), Application Specific Standard Products (ASSPs), System on Chip (SOCs), Complex Programmable Logic Devices (CPLDs), etc.

In the context of the present disclosure, a machine readable medium may be a tangible medium that can contain, or store a program for use by or in connection with an instruction execution system, apparatus, or device. The machine readable medium may be a machine readable signal medium or a machine readable storage medium. A machine readable medium may include, but is not limited to, an electronic, magnetic, optical, electromagnetic, infrared, or semiconductor system, apparatus, or device, or any suitable combination of the foregoing. Examples of the machine readable storage medium would include an electrical connection based on one or more wires, a portable computer diskette, a hard disk, a random access memory (RAM), a read-only memory (ROM), an erasable programmable read-only memory (EPROM) or Flash memory, an optical fiber, a convenient compact disc read-only memory (CD-ROM), an optical storage device, a magnetic storage device, or any suitable combination of the foregoing.

According to one or more embodiments of the embodiment of the disclosure, an embodiment of the disclosure discloses a method for generating effect characters, including:
transforming an original monochrome character image into a color character image;
magnifying a set edge in the color character image in a first direction to obtain a stretch effect image;
acquiring a plurality of set noise images, and disturbing pixel points in a set region of the stretch effect image in a second direction respectively according to the plurality of set noise images, to obtain a plurality of effect character images, wherein the set region includes a stretch region; and
splice-coding the plurality of effect character images to obtain dynamic effect character.

In an embodiment, the transforming an original monochrome character image into a color character image includes:
copying the original monochromatic character image in multiple copies to obtain a plurality of copied monochromatic character images;
mapping characters in the plurality of copied monochrome character images to different colors, respectively, to obtain a plurality of color images;
moving the plurality of color images by at least partially different offsets in the second direction, respectively;
color filter overlaying a plurality of shifted color images and the original monochromatic character image to obtain an overlaid image; and
masking the overlaid image by using the original monochrome character image to obtain a color character image.

In an embodiment, after transforming the original monochrome character image into a color character image, the method further includes:
edge distorting color characters in the color character image to obtain an edge distorted color image;
In an embodiment, the magnifying a set edge in the color character image in a first direction to obtain a stretch effect image, including:
magnifying a distorted edge of the edge distorted color image in the first direction to obtain a stretch effect image.

In an embodiment, the edge distorting color characters in the color character image to obtain an edge distorted color image includes:
acquiring a stripe noise image; and
disturbing edges of the color characters in the color character image in the first direction according to grayscale information of the stripe noise image to obtain the edge distorted color image.

In an embodiment, the disturbing edges of the color characters in the color character image in the first direction according to grayscale information of the stripe noise image to obtain the edge distorted color image includes:
aligning the stripe noise image with the color character image;
acquiring, for each pixel point of edge portions of the color characters, grayscale information of a pixel point aligned with the each pixel point in a stripe noise image;
accumulating the grayscale information with a coordinate value of the each pixel point in the first direction to obtain a first direction coordinate value of disturbed pixel point, to obtain the edge distorted color image.

In an embodiment, after obtaining the stretch effect image, the method further includes:
hybrid overlaying the original monochromatic character image with the stretch effect image to obtain an overlaid stretch effect image.

In an embodiment, the hybrid overlaying the original monochromatic character image with the stretch effect image to obtain an overlaid stretch effect image includes:
blurring the stretch effect image with a first blur degree to obtain a first blurred stretch image;
hybridizing the first blurred stretch image and the stretch effect image according to a set hybrid rule to obtain a first hybrid image; and
aligning characters in the original monochromatic character image with characters in the first hybrid image and shifting aligned characters in the original monochromatic character image by a set offset in the second direction to obtain the overlaid stretch effect image, wherein the characters of the original monochromatic character image in the overlaid stretch effect image is positioned above the characters of the first hybrid image.

In an embodiment, the hybridizing the first blurred stretch image and the stretch effect image according to a set hybrid rule to obtain a first hybrid image includes:
aligning the first blurred stretch image and the stretch effect image, and acquiring first direction coordinate values of aligned pixel points;
determining a hybrid ratio according to the first direction coordinate values; and
hybridizing the aligned pixel points according to the hybrid ratio to obtain the first hybrid image, wherein the hybrid ratio is a ratio of the stretch effect image to the first blurred stretch image.

In an embodiment, the hybrid overlaying the original monochromatic character image with the stretch effect image to obtain an overlaid stretch effect image includes:
blurring the stretch effect image with a second blur degree to obtain a second blurred stretch image, wherein the second blur degree is less than the first blur degree;
hybridizing the first blur stretch image and the second blur stretch image according to a set hybrid rule to obtain a second hybrid image; and
aligning the characters in the original monochromatic character image with characters in the second hybrid image, and shifting aligned characters in the original monochromatic character image by a set offset in the second direction to obtain the overlaid stretch effect image, wherein the characters of the original monochromatic character image in the overlaid stretch effect image is positioned above the characters of the second hybrid image.

In an embodiment, the acquiring a plurality of set noise images, and disturbing pixel points in a set region of the stretch effect image in a second direction respectively according to the plurality of set noise images, to obtain a plurality of effect character images, includes:
aligning the set noise image with the stretch effect image,
acquiring, for each pixel point of the set region, grayscale information of a pixel point aligned with the each pixel point in a set noise image; and
accumulating the grayscale information and coordinate value of the each pixel point in the second direction to obtain a second direction coordinate value of a disturbed pixel point, to obtain the effect character image.

In an embodiment, the accumulating the grayscale information and a coordinate value of the each pixel point in the second direction to obtain a second direction coordinate value of a disturbed pixel point includes:
determining an accumulated weight based on a distance of the each pixel point from characters in the first direction, wherein the accumulated weight is inversely proportional to the distance; and
accumulating a result obtained by multiplying the grayscale information with the accumulated weight with the coordinate value of the each pixel point in the second direction to obtain the second direction coordinate value of the disturbed pixel point.

In an embodiment, after obtaining the plurality of effect character images, the method further includes:
periodically adjusting intensity coefficients of saturation levels of the plurality of effect character images.

In an embodiment, after obtaining the plurality of effect character images, the method further including:
determining, for each pixel point in the set region, index information according to grayscale information of the each pixel point and time stamp information of a current effect character image;
obtaining a target color from a set color bar according to the index information; and
replacing a color of the each pixel point with the target color.

The present disclosure is not limited only to the above embodiments, but may also include many other equivalent embodiments without departing from the concept of the present disclosure, and the scope of the present disclosure is determined by the scope of the appended claims.

What is claimed is:

1. A method for generating effect character, comprising:
transforming an original monochrome character image into a color character image;
magnifying a set edge in the color character image in a first direction to obtain a stretch effect image;
acquiring a plurality of set noise images, and disturbing pixel points in a set region of the stretch effect image in a second direction respectively according to the plurality of set noise images, to obtain a plurality of effect character images, wherein the set region comprises a stretch region; and
splice-coding the plurality of effect character images to obtain dynamic effect character.

2. The method according to claim 1, wherein the transforming an original monochrome character image into a color character image comprises:
copying the original monochromatic character image in multiple copies to obtain a plurality of copied monochromatic character images;
mapping characters in the plurality of copied monochrome character images to different colors, respectively, to obtain a plurality of color images;
moving the plurality of color images by at least partially different offsets in the second direction, respectively;
color filter overlaying a plurality of shifted color images and the original monochromatic character image to obtain an overlaid image; and
masking the overlaid image by using the original monochrome character image to obtain a color character image.

3. The method according to claim 1, wherein after transforming the original monochrome character image into a color character image, the method further comprises:
edge distorting color characters in the color character image to obtain an edge distorted color image;
wherein the magnifying a set edge in the color character image in a first direction to obtain a stretch effect image, comprising: magnifying a distorted edge of the edge distorted color image in the first direction to obtain a stretch effect image.

4. The method according to claim 3, wherein the edge distorting color characters in the color character image to obtain an edge distorted color image comprises:
acquiring a stripe noise image; and
disturbing edges of the color characters in the color character image in the first direction according to grayscale information of the stripe noise image to obtain the edge distorted color image.

5. The method according to claim 4, wherein the disturbing edges of the color characters in the color character image in the first direction according to grayscale information of the stripe noise image to obtain the edge distorted color image comprises:
aligning the stripe noise image with the color character image;
acquiring, for each pixel point of edge portions of the color characters, grayscale information of a pixel point aligned with the each pixel point in a stripe noise image;
accumulating the grayscale information with a coordinate value of the each pixel point in the first direction to obtain a first direction coordinate value of disturbed pixel point, to obtain the edge distorted color image.

6. The method according to claim 1, wherein after obtaining the stretch effect image, the method further comprises:
hybrid overlaying the original monochromatic character image with the stretch effect image to obtain an overlaid stretch effect image.

7. The method according to claim 6, wherein the hybrid overlaying the original monochromatic character image with the stretch effect image to obtain an overlaid stretch effect image comprises:
blurring the stretch effect image with a first blur degree to obtain a first blurred stretch image;
hybridizing the first blurred stretch image and the stretch effect image according to a set hybrid rule to obtain a first hybrid image; and
aligning characters in the original monochromatic character image with characters in the first hybrid image and shifting aligned characters in the original monochromatic character image by a set offset in the second direction to obtain the overlaid stretch effect image, wherein the characters of the original monochromatic character image in the overlaid stretch effect image is positioned above the characters of the first hybrid image.

8. The method according to claim 7, wherein the hybridizing the first blurred stretch image and the stretch effect image according to a set hybrid rule to obtain a first hybrid image comprises:
aligning the first blurred stretch image and the stretch effect image, and acquiring first direction coordinate values of aligned pixel points;
determining a hybrid ratio according to the first direction coordinate values; and
hybridizing the aligned pixel points according to the hybrid ratio to obtain the first hybrid image, wherein the hybrid ratio is a ratio of the stretch effect image to the first blurred stretch image.

9. The method according to claim 7, wherein the hybrid overlaying the original monochromatic character image with the stretch effect image to obtain an overlaid stretch effect image comprises:
blurring the stretch effect image with a second blur degree to obtain a second blurred stretch image, wherein the second blur degree is less than the first blur degree;
hybridizing the first blur stretch image and the second blur stretch image according to a set hybrid rule to obtain a second hybrid image; and
aligning the characters in the original monochromatic character image with characters in the second hybrid image, and shifting aligned characters in the original monochromatic character image by a set offset in the second direction to obtain the overlaid stretch effect image, wherein the characters of the original monochromatic character image in the overlaid stretch effect image is positioned above the characters of the second hybrid image.

10. The method according to claim 1, wherein the acquiring a plurality of set noise images, and disturbing pixel points in a set region of the stretch effect image in a second direction respectively according to the plurality of set noise images, to obtain a plurality of effect character images, comprises:
aligning the set noise image with the stretch effect image,
acquiring, for each pixel point of the set region, grayscale information of a pixel point aligned with the each pixel point in a set noise image; and
accumulating the grayscale information and coordinate value of the each pixel point in the second direction to obtain a second direction coordinate value of a disturbed pixel point, to obtain the effect character image.

11. The method according to claim 10, wherein the accumulating the grayscale information and a coordinate value of the each pixel point in the second direction to obtain a second direction coordinate value of a disturbed pixel point comprises:
determining an accumulated weight based on a distance of the each pixel point from characters in the first direction, wherein the accumulated weight is inversely proportional to the distance; and
accumulating a result obtained by multiplying the grayscale information with the accumulated weight with the coordinate value of the each pixel point in the second direction to obtain the second direction coordinate value of the disturbed pixel point.

12. The method according to claim 1, wherein after obtaining the plurality of effect character images, the method further comprises:
periodically adjusting intensity coefficients of saturation levels of the plurality of effect character images.

13. The method according to claim 1, wherein after obtaining the plurality of effect character images, the method further comprising:
determining, for each pixel point in the set region, index information according to grayscale information of the each pixel point and time stamp information of a current effect character image;
obtaining a target color from a set color bar according to the index information; and
replacing a color of the each pixel point with the target color.

14. (canceled)

15. An electronic device, comprising:
one or more processing devices;
a storage device, configured to store one or more programs;
the one or more programs, when executed by the one or more processing devices, cause the one or more processing devices to implement a method for generating effect character, the method comprises:
transforming an original monochrome character image into a color character image;
magnifying a set edge in the color character image in a first direction to obtain a stretch effect image;
acquiring a plurality of set noise images, and disturbing pixel points in a set region of the stretch effect image in a second direction respectively according to the plurality of set noise images, to obtain a plurality of effect character images, wherein the set region comprises a stretch region; and
splice-coding the plurality of effect character images to obtain dynamic effect character.

16. A non-transitory computer readable medium having stored thereon a computer program which, when executed by a processing device, implements a method of generating effect character, the method comprises:
transforming an original monochrome character image into a color character image;
magnifying a set edge in the color character image in a first direction to obtain a stretch effect image;
acquiring a plurality of set noise images, and disturbing pixel points in a set region of the stretch effect image in a second direction respectively according to the plurality of set noise images, to obtain a plurality of effect character images, wherein the set region comprises a stretch region; and
splice-coding the plurality of effect character images to obtain dynamic effect character.

17. The electronic device according to claim 15, wherein the transforming an original monochrome character image into a color character image comprises:
copying the original monochromatic character image in multiple copies to obtain a plurality of copied monochromatic character images;
mapping characters in the plurality of copied monochrome character images to different colors, respectively, to obtain a plurality of color images;
moving the plurality of color images by at least partially different offsets in the second direction, respectively;
color filter overlaying a plurality of shifted color images and the original monochromatic character image to obtain an overlaid image; and
masking the overlaid image by using the original monochrome character image to obtain a color character image.

18. The electronic device according to claim 15, wherein after transforming the original monochrome character image into a color character image, the method further comprises:
edge distorting color characters in the color character image to obtain an edge distorted color image;
wherein the magnifying a set edge in the color character image in a first direction to obtain a stretch effect image, comprising: magnifying a distorted edge of the edge distorted color image in the first direction to obtain a stretch effect image.

19. The electronic device according to claim 18, wherein the edge distorting color characters in the color character image to obtain an edge distorted color image comprises:
acquiring a stripe noise image; and
disturbing edges of the color characters in the color character image in the first direction according to grayscale information of the stripe noise image to obtain the edge distorted color image.

20. The electronic device according to claim 19, wherein the disturbing edges of the color characters in the color character image in the first direction according to grayscale information of the stripe noise image to obtain the edge distorted color image comprises:
aligning the stripe noise image with the color character image;
acquiring, for each pixel point of edge portions of the color characters, grayscale information of a pixel point aligned with the each pixel point in a stripe noise image;
accumulating the grayscale information with a coordinate value of the each pixel point in the first direction to obtain a first direction coordinate value of disturbed pixel point, to obtain the edge distorted color image.

21. The electronic device according to claim 15, wherein after obtaining the stretch effect image, the method further comprises:
hybrid overlaying the original monochromatic character image with the stretch effect image to obtain an overlaid stretch effect image.
